(19) United States
(12) Patent Application Publication
(10) Pub. No.: US 2007/0041225 A1
(43) Pub. Date: Feb. 22, 2007

(54) Method and drive circuit for driving a switch in a switched-mode converter

(75) Inventor: Marc Fahlenkamp, Geretsried (DE)

Correspondence Address: Maginot, Moore & Beck;Chase Tower, Suite 3250, 111 Monument Circle, Indianapolis, IN, 46204, US

(73) Assignee: Infineon Technologies Austria AG, Villach (AT)

(21) Appl. No.: 11/506,156

(22) Filed: Aug. 16, 2006

(30) Foreign Application Priority Data
Aug. 16, 2005 (DE) 102005038660.1-32

(51) Int. Cl. H02M 3/335

(52) U.S. Cl. 363/21.01

(57) ABSTRACT

A method drives a semiconductor switch, which is connected in series with a first coil of a transformer in a switched-mode converter. The method includes driving the switch continuously using a first pulse-width-modulated drive signal. The method further includes driving the switch intermittently using a second pulse-width-modulated signal, responsive to whether a maximum value of a current through the first coil exceeds a predetermined current threshold value during at least one drive period of the first pulse-width-modulated drive signal. Typically, the change from continuous to intermittent drive occurs when the maximum value of a current does not exceed a predetermined current threshold value during at least one drive period or cycle.

### FIELD OF THE INVENTION

The present invention relates to a method for driving a switch controlling the power consumption of an inductive energy storage element in a switched-mode converter and to a drive circuit for driving such a switch in a switched-mode converter, particularly in a blocking-oscillator-type converter operated in current mode.

### BACKGROUND

A blocking-oscillator-type converter operated in current mode is described, for example, in WO 2004/030194 A1, which is incorporated herein by reference. The power consumption in such a blocking-oscillator-type converter is controlled in a familiar manner by driving a switch, connected in series with the primary coil of the transformer, with a pulse-width-modulated drive signal with variable duty cycle. The power consumption is controlled via the duty cycle such that the greater the duty cycle, the greater the power consumed. In other words, power consumption increases as the ratio increases between the on-time of the switch and the total time of a drive period comprising the on-time and an off-time. The pulse-width-modulated signal is generated in current mode in that the switch is switched on clocked and a signal proportional to the current through the primary coil, which rises in the form of a ramp after the semiconductor switch has turned on, is compared with a control signal dependent on the output voltage. The switch is switched off again when the ramp-shaped signal reaches the control signal.

This type of control leads to relatively short on-times of the switch in the so-called low-load mode of operation. A low-load mode of operation is when the switched-mode converter supplies a load with low power consumption. The switching losses unavoidably present with each switching process can make up a considerable proportion of the total power consumed in low-load operation.

To reduce the switching losses, it is known to operate switched-mode converters in low-load operation in a so-called “burst mode”. During this operating mode, the switch is only driven interval by interval by a pulse-width-modulated drive signal and is permanently cut off between such drive intervals.

In the abovementioned WO 2004/030194 A1, a method is described in which the drive to the switch is interrupted during the rest mode when the output voltage exceeds a predetermined threshold value. If the output voltage then drops, a pulse-width-modulated drive is begun when the output voltage drops below a predetermined lower threshold value. Such cycles with pulse-width-modulated drive with interruption of the drive following the pulse-width-modulated drive are continued until the power consumption of a connected load increases to such an extent that the output voltage drops below a second lower threshold value during the burst mode. In this case, the system switches back to normal mode in which there is permanent pulse-width-modulated drive to the switch.

In the known method, the information about the output voltage is taken from the control signal fed back, which is dependent on the output voltage, so that the system switches between a pulse-width-modulated drive and an interruption to the drive during the burst mode in dependence on a comparison of the control signal with suitable threshold values.

In the known method, the transition from normal operating mode into the burst mode also takes place in dependence on the control signal. In the burst mode, switch-over occurs in this method when the feedback signal reaches a threshold value which points to an increase in the output voltage up to the upper threshold value.

Due to unavoidably existing signal delays in the circuit evaluating the control signal, switch-over into burst mode in dependence on the control signal leads to switch-over into burst mode occuring in dependence on the input voltage present at the switched-mode converter with different power consumptions. In a switched-mode converter operated in current mode, the on-time is automatically reduced, the control signal remaining the same, when the input voltage of the switched-mode converter increases. The steepness of the ramps of the ramp-shaped signal derived from the input current increases with increasing input voltage so that this signal, with increasing input voltage, reaches the value of the control signal earlier as a result of which the on-times become shorter overall. Unavoidably present signal delays then lead to the switch in each case still remaining switched on for the duration of the signal delays after the ramp signal has risen up to the value of the control signal. The energy still consumed during this delay time is dependent on the input voltage and is greater with greater input voltage. This additional power consumption due to the signal delays, which is dependent on input voltage, leads to the control signal assuming different values with a given power consumption in dependence on the input voltage. This, in turn, leads to a switch-over into burst mode in dependence on the input voltage with different power consumptions.

### SUMMARY

It is the aim of at least some embodiments of the invention to provide a method for driving a semiconductor switch (and a drive circuit) that addresses one or more of the foregoing shortcomings of the prior art. To this end, at least some embodiments switch from a continuous pulse-width-modulated signal to an intermittent modulated signal based at least in part on the current through the drive circuit.

A first embodiment of the invention is a method for driving a semiconductor switch, which is connected in series with a first coil of a transformer in a switched-mode converter. The method includes driving the switch continuously using a first pulse-width-modulated drive signal. The method further includes driving the switch intermittently using a second pulse-width-modulated signal, responsive to whether a maximum value of a current through the first coil exceeds a predetermined current threshold value during at least one drive period of the first pulse-width-modulated drive signal. Typically, the change from continuous to intermittent drive occurs when the maximum value of a current does not exceed a predetermined current threshold value during at least one drive period or cycle.

In the text that follows, the invention will be explained in greater detail with reference to figures.

### BRIEF DESCRIPTION OF THE DRAWINGS

FIG. 1 shows a switched-mode converter, constructed as blocking-oscillator-type converter, with a switch connected in series with a primary coil of a transformer and a drive circuit according to an embodiment of the invention for driving the switch.

FIG. 2 shows the generation of the drive signal by the drive circuit for a first drive.

FIG. 3 diagrammatically shows the variation of a current measurement signal which is dependent on a current through the primary coil, in dependence on a control signal controlling the power consumption.

FIG. 4 shows the operation of the drive circuit during the second drive mode.

FIG. 5 shows a state diagram for the drive circuit for explaining the transition from a first into a second drive mode and conversely.

FIG. 6 shows a first exemplary circuit implementation of the drive circuit.

FIG. 7 shows an exemplary implementation of an evaluating circuit determining the transition from the first into the second drive mode and present in the drive circuit.

FIG. 8 shows time variations of selected signals occurring in the evaluating circuit according to FIG. 7.

FIG. 9 shows a second exemplary embodiment of the evaluating circuit.

FIG. 10 shows a third exemplary embodiment of the evaluating circuit.

FIG. 11 shows by way of example time variations of selected signals occurring in the evaluating circuit according to FIG. 10.

FIG. 12 shows a second exemplary embodiment of the drive circuit.

FIG. 13 shows a third exemplary embodiment of the drive circuit.

FIG. 14 shows a fourth exemplary embodiment of the drive circuit.

### DETAILED DESCRIPTION

A first embodiment of the invention is a method for driving a switch, connected in series with a primary coil of a transformer and controlling the power consumption, in a switched-mode converter, it is provided that a change from a first rive mode in which the switch is permanently (i.e. continuously) driven by a pulse-width-modulated drive signal, into a second drive mode in which the switch is driven interval by interval (i.e. intermittently) by a pulse-width-modulated drive signal, takes place in dependence on whether the maximum value of a current through the primary coil exceeds a predetermined current threshold value during at least one drive period.

The above embodiment makes use of the finding that in the case of a switched-mode converter operated in a discontinuous current mode, the power consumption is dependent exclusively on the inductance of the transformer, the duration of the period or the frequency of the pulse-width-modulated drive signal and the maximum value of the current flowing through the primary coil during a drive period. The following applies:
P=0.5·L·Imax²·f=0.5·L·Imax²/T (1)
where L is the inductance of the primary coil, Imax is the maximum value reached by the current through the primary coil during one drive period, f is the frequency with which the switch is switched on at regular time intervals by the pulse-width-modulated drive signal, and T is the duration of a drive period of the pulse-width-modulated drive signal, this drive period comprising an on-time and an off-time.

In the embodiment described above, in which the transition from the first drive mode, corresponding to normal operation, into the second drive mode, corresponding to a burst mode, takes place in dependence on the current through the primary coil or in dependence on a current measurement signal proportional to this current, it is advantageous if this transition takes place substantially independently of the input voltage whenever the power consumed by the load drops below a given power limit value which defines the transition to low-load operation.

A change from the first into the second operating mode preferably only takes place when the maximum value of the current through the primary coil remains below the current threshold value defining the low-load mode during a predetermined number of successive drive periods. This ensures that a transition to the second drive mode does not already occur when the maximum value of the current through the primary coil has remained below the current threshold value only once as a result of interfering effects.

The drive circuit according one embodiment for a semiconductor switch, connected in series with a primary coil of a transformer and determining the power consumption, in a switched-mode converter has an output terminal for providing a drive signal for the semiconductor switch, a measuring input for supplying a measurement signal depending on a current through the primary coil, a feedback input for supplying a control signal depending on an output voltage of the switched-mode converter and controlling the power consumption, and a signal generating circuit. The signal generating circuit is constructed for generating a pulse-width-modulated signal as drive signal permanently in a first drive mode, and is constructed for generating a pulse-width-modulated signal as drive signal interval-by-interval in a second drive mode. A transition from the first into the second operating mode takes place in dependence on the current measurement signal. In the figures, identical reference symbols designate identical circuit components and signals having identical significance, unless otherwise specified.

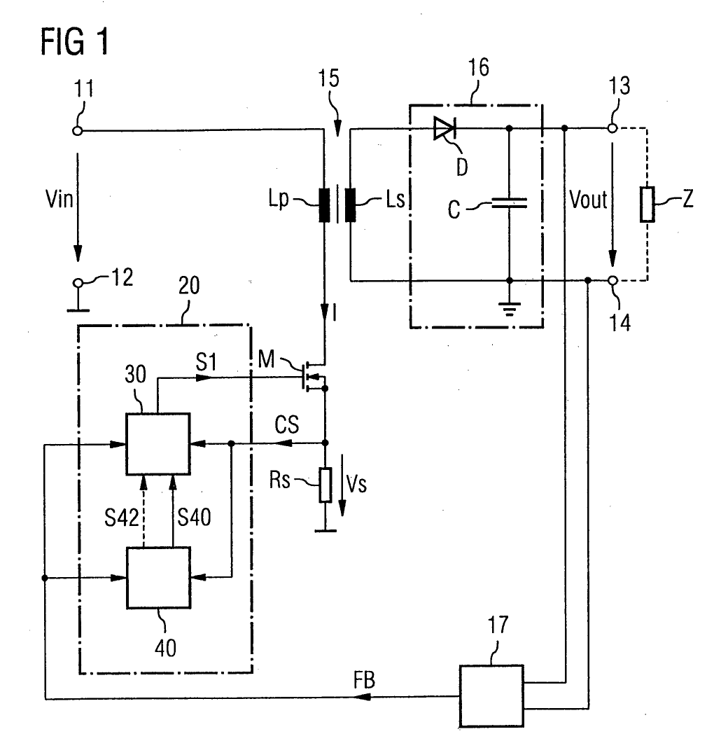

FIG. 1 shows a block diagram of a drive circuit 20 according to an embodiment of the invention for driving a switch M, controlling the power consumption, in a switched-mode converter which is constructed as blocking-oscillator-type converter in the example.

To provide better understanding, the remaining components of this switched-mode converter are also shown in FIG. 1, in addition to the drive circuit 20. The switched-mode converter has input terminals 11, 12 for applying an input voltage Vin, and output terminals 13, 14 for providing an output voltage Vout. The inputs and outputs 11 to 14 are DC-decoupled by a transformer 15, the primary coil Lp is connected in series with the switch M. In the example, the switch M is constructed as semiconductor switch, especially as MOSFET. The input voltage Vin is present across the series circuit with the primary coil Lp and the semiconductor switch M. A secondary coil Ls of the transformer 15 is followed by a rectifier arrangement 16 which has a rectifier element D constructed as diode and a capacitor C in the example. Outputs of this rectifier arrangement 16 form the outputs 13, 14 of the switched-mode converter.

A control arrangement 17 detects the output voltage Vout and generates a control signal or feedback signal FB dependent on this output voltage Vout. This control arrangement 17 is constructed, for example, for comparing the output voltage Vout with a reference voltage in order to generate an error signal. The feedback signal FB is dependent on the error signal, there being preferably a proportional or proportional-integral dependence of the feedback signal FB on the error signal. Such control arrangements 17 are adequately well known so that further statements relating to these can be omitted.

The drive circuit 20 has a pulse-width-modulator 30 which is supplied with the control signal FB dependent on the output voltage Vout, which is available at the output of the control arrangement 17. The pulse width modulator 30 is also supplied with a current measurement signal CS, which is dependent on a current I through the primary coil Lp, which, in the example shown, corresponds to the voltage Vs across a current measuring resistor Rs connected in series with the semiconductor switch M and, as a result, is proportional to the current I through the primary coil Lp. This current I through the primary coil Lp forms the input current to the switched-mode converter.

The drive circuit 20 also has an enable circuit 40 which is also supplied with the current measurement signal CS and the control signal FB and which is constructed for generating an enable signal S40 which is supplied to the pulse-width-modulator 30. This enable signal S40 is used for enabling the pulse-width modulator 30 for generating a pulse-width-modulated drive signal or blocking the pulse-width-modulator 30 in such a manner that there is no pulse-width-modulated drive to the semiconductor switch M.

The drive circuit 20 is capable of assuming two different operating modes: a first operating mode in which the pulse-width modulator 30 is permanently enabled via the enable signal S40 in order to generate a pulse-width-modulated drive signal S1 for the semiconductor switch M, and a second operating mode in which the pulse width modulator 30 is blocked at least once for a time interval by the enable signal and is subsequently enabled again. In the embodiment described herein, this first operating mode will be called normal mode in the text which follows and the second operating mode will be called burst mode in the text which follows. The drive to the switch M during the first operating mode will be called drive in normal mode in the text which follows and the drive to the switch M during the second operating mode will be called drive in burst mode in the text which follows.

The respective operating mode is predetermined by the enable circuit 40 in dependence on the control signal FB and the current measurement signal CS. The type of generation of the pulse-width-modulated signal by the pulse-width modulator 30 can be different for normal mode and for burst mode. For this purpose, the enable circuit 40 provides, apart from the enable signal S40, also an operating mode signal S42 which contains the information about the respective operating mode. The different types of generation of the pulse-width-modulated drive signal during the individual operating modes will still be explained in the text which follows.

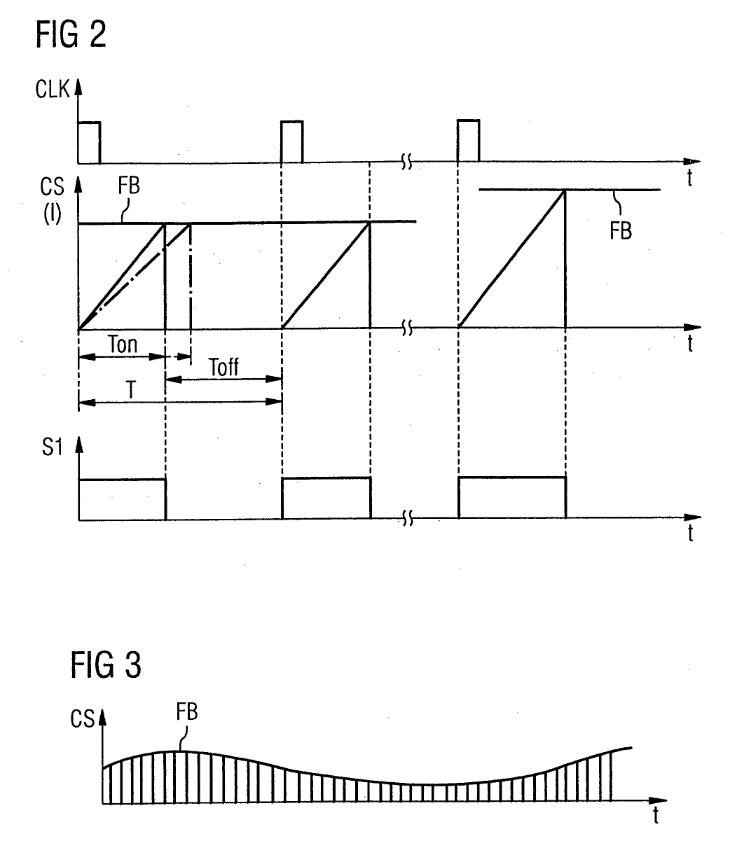

FIG. 2 illustrates the operation of the pulse-width modulator 30 during normal mode. During this normal mode, the semiconductor switch M is driven pulse-width-modulated by the drive signal S1. The individual drive pulses of this drive signal S1 begin at regular time intervals as determined by an internal clock signal CLK generated in the pulse-width modulator 30. The duration of the period of this clock signal CLK is T. Its frequency f is f=1/T. As the semiconductor switch M is switched on, the input current I, and thus the current measurement signal CS proportional to this current I, begins to rise in the form of a ramp. The individual drive pulses of the drive signal S1 in each case end when the current measurement signal CS has risen to the value of the control signal FB fed back. In FIG. 2, Ton designates the duration of one of the drive pulses, i.e. the on-time of the switch M during a drive period T. Toff designates the subsequent off-time up to the next beginning of an on-time Ton.

As can be seen, this on-time Ton increases with increasing control signal FB, and in the example according to FIG. 2 it is assumed that the control signal FB is generated in such a manner that this control signal FB rises with increasing power consumption of a load (Z in FIG. 1) connected to the output terminals (13, 14 in FIG. 1), or with dropping output voltage Vout, respectively.

In addition, the on-time Ton is also dependent on the input voltage Vin, the control signal FB remaining the same. If the input voltage Vin is reduced, the rate of increase of the input current slows down, and thus the rise of the individual edges of the ramp-shaped current measurement signal CS as a result of the on-time increases which is shown dot-dashed for one of the ramps in FIG. 2.

As can be seen from FIG. 3, in particular, in which only the maximum values CSmax of the current measurement signal CS during a number of successive drive periods are shown, these maximum values CSmax follow the control signal FB during normal mode. Due to the proportionality between the input current I and the current measurement signal CS, the respective maximum value Imax of the input current correspondingly follows a value proportional to the control signal and the current consumption rises when the control signal increases.

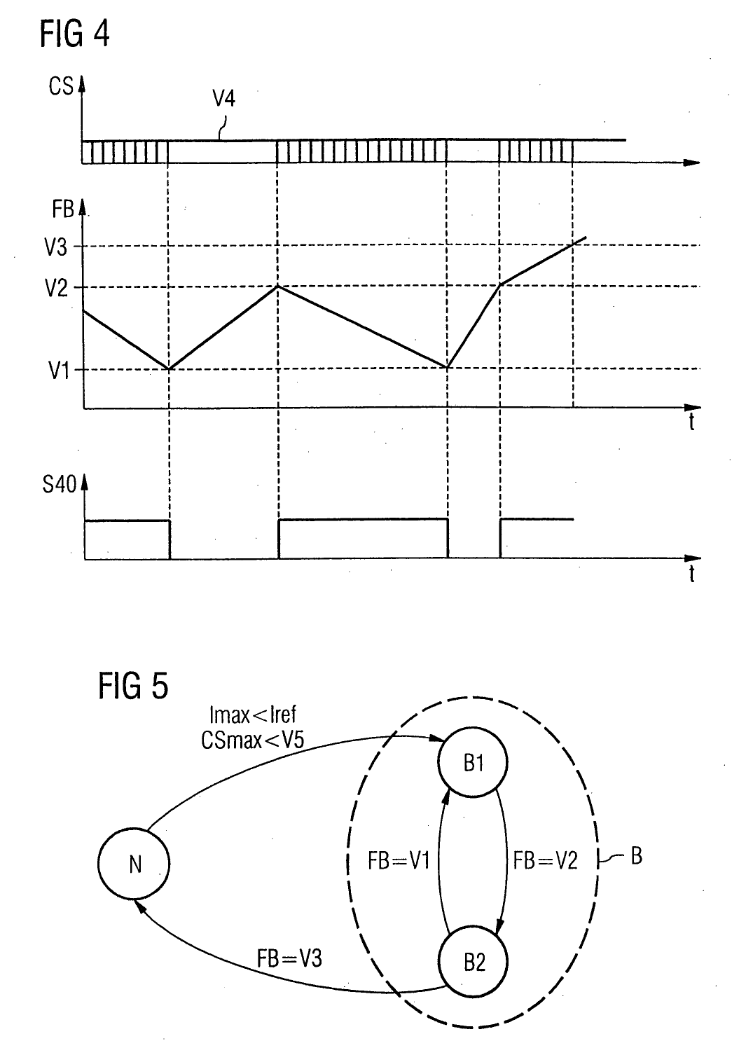

FIG. 4 illustrates the operation of the drive circuit 20 during the burst mode. During this operating mode, there are two sub-operating modes, a first sub-operating mode in which the pulse width modulator (30 in FIG. 1) is enabled and generates a pulse-width-modulated drive signal S1 for the semiconductor switch M, and a second sub-operating mode in which the pulse width modulator 30 is blocked. A change between these two sub-operating modes takes place in dependence on a comparison of the control signal FB with a first and second threshold value V1, V2. In the example, the first threshold value V1 represents a lower threshold value whereas the second threshold value V2 represents a first upper threshold value.

In the example shown, it is assumed that the control signal drops when the output voltage rises and that the control signal rises when the output voltage drops. If the control signal FB drops to the first threshold value V1 during the burst mode, which indicates that the output voltage Vout has risen above a predetermined limit value or, respectively, that the power consumption of the load has dropped below a predetermined limit value, the pulse-width modulator 30 is blocked.

Assuming that the load Z is continuing to consume power, the output voltage Vout drops with the pulse width modulator 30 blocked and subsequently interrupted power consumption of the switched-mode converter as a result of which the control signal FB rises. If the control signal reaches the second threshold value V2 which indicates that the output voltage Vout has dropped below a first lower limit value, the pulse width modulator 30 is enabled again and generates a pulse-width-modulated drive signal for the semiconductor switch M. If the power consumption of the load Z is lower than the power supplied by the switched-mode converter, the output voltage Vout subsequently rises again and the control signal FB correspondingly drops again. If the control signal FB reaches the first threshold value V1 again, the pulse width modulator 30 is blocked again.

This cycle of alternating blocking and enabling of the pulse width modulator 30 is repeated until the power consumption of the load Z rises to such an extent that its power demand can no longer be covered during an interval during which the switch is driven pulse-width-modulated. As a consequence, the control signal FB rises to a third threshold value which is greater than the second threshold value V2 and which represents a second upper threshold value. The rise in the control signal to this second upper threshold value is equivalent to the output voltage Vout dropping below a second lower limit value which is lower than the first lower limit value. In this case, the system switches from burst mode to normal mode in order to ensure adequate power supply for the load.

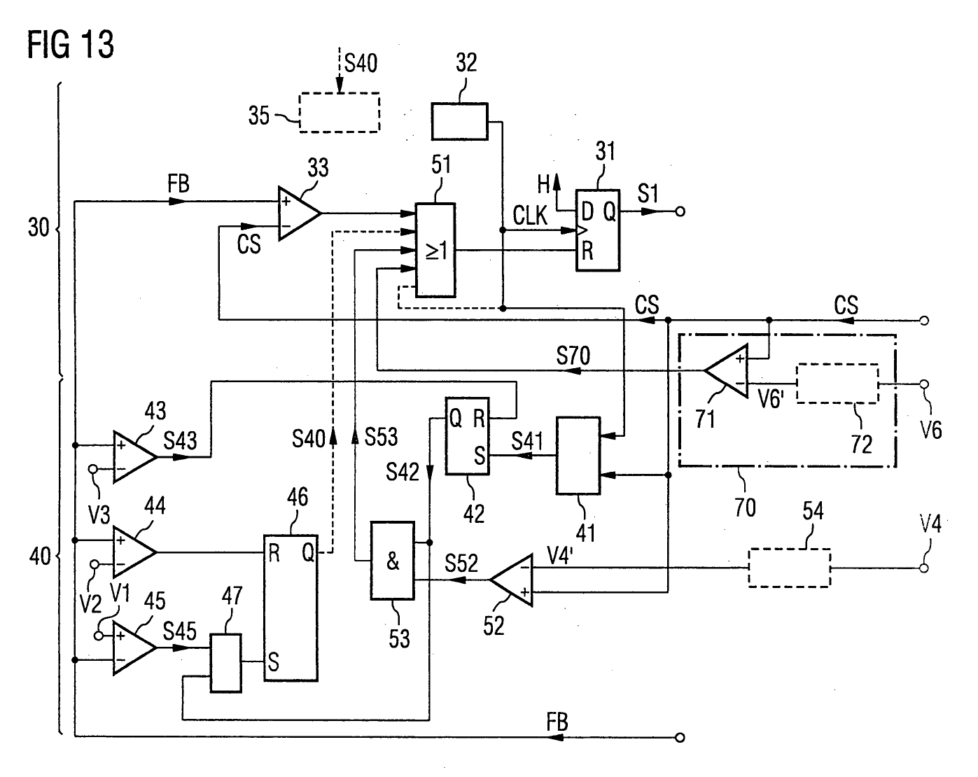

It should be noted in this context that the maximum power consumption of the switched-mode converter is preferably lower during burst mode than the power consumption during normal mode. This is achieved, for example, by the semiconductor switch M being switched off again during the burst mode during the individual drive periods when the current measurement signal CS reaches a constant threshold value which will also be called current limiting value for the burst mode in the text which follows. This threshold value is designated by V4 in FIG. 4, in the upper part of which the maximum values of the measurement signal CS during the individual phases of the burst mode are shown. This current limiting value V4 is selected in such a manner that it is lower than the values assumed by the control signal FB—which predetermines the maximum amplitude of the input current during normal mode—during the normal mode. As a result, the duty cycle of the pulse-width-modulated drive signal is less during burst mode than during normal mode. The current limiting value V4 for the burst mode V4 is selected in such a manner that it is lower than the lower threshold value V1 to which the control signal FB can drop during the burst mode. The current limiting value V4 for the burst mode is, for example, about 25% of a current limiting value (V6 in FIG. 13), still to be explained, for the normal mode.

For the transition from normal mode into burst mode, it is provided that this transition takes place when the input current I remains below a predetermined current threshold value Iref during at least one drive period, that is to say when the maximum value Imax of the input current I reached during a drive period is lower than this current threshold value Iref. This is equivalent to a maximum value of the current measurement signal CS remaining below a limit value, which will be called normal mode limit value V5 in the text which follows, during at least one drive period of the switch M.

The individual operating modes of the drive circuit or, respectively, the individual drive modes of the semiconductor switch will become particularly clear when referring to the state diagram shown in FIG. 5. In this state diagram, N designates the normal mode and B designates the burst mode. B1 designates the first submode during the burst mode in which the pulse width modulator 30 is blocked, and B2 designates the second submode during the burst mode in which the pulse width modulator 30 is enabled, in order to generate a pulse-width-modulated signal - with a duty cycle which is reduced compared with normal mode.

The transition from normal mode N into burst mode B takes place when the maximum input current Imax remains below the current threshold value Iref during at least one drive period, which is equivalent to the maximum value CSmax of the current measurement signal CS remaining below the normal mode limit value V5. On transition from normal mode N into burst mode B, the pulse width modulator 30 is initially blocked, that is to say there is a transition into the first submode B1. As a result, the output voltage drops and the control signal FB rises. Within the burst mode B, the pulse width modulator 30 is enabled when the control signal FB has risen up to the second threshold value V2. It should be noted in this context that the current threshold value Iref or, respectively, the normal mode limit value V5 are selected in such a manner that the control signal FB is reliably lower than the second threshold value V2 when a state is reached in which the maximum input current is lower than the current threshold value Iref.

In the burst mode, the transition from the second submode B2 into the first submode B1 occurs when the control signal FB has dropped down to the first threshold value V1. The transition from burst mode B into normal mode N occurs when the control signal FB has risen up to the third threshold value V3.

For the previous explanations, it has been assumed that the control signal FB increases with decreasing output voltage Vout, and conversely. Naturally, the circuit operates correspondingly when a control signal FB is selected which increases with increasing output voltage Vout. In this case, the reference threshold values V1-V3 must be changed correspondingly.

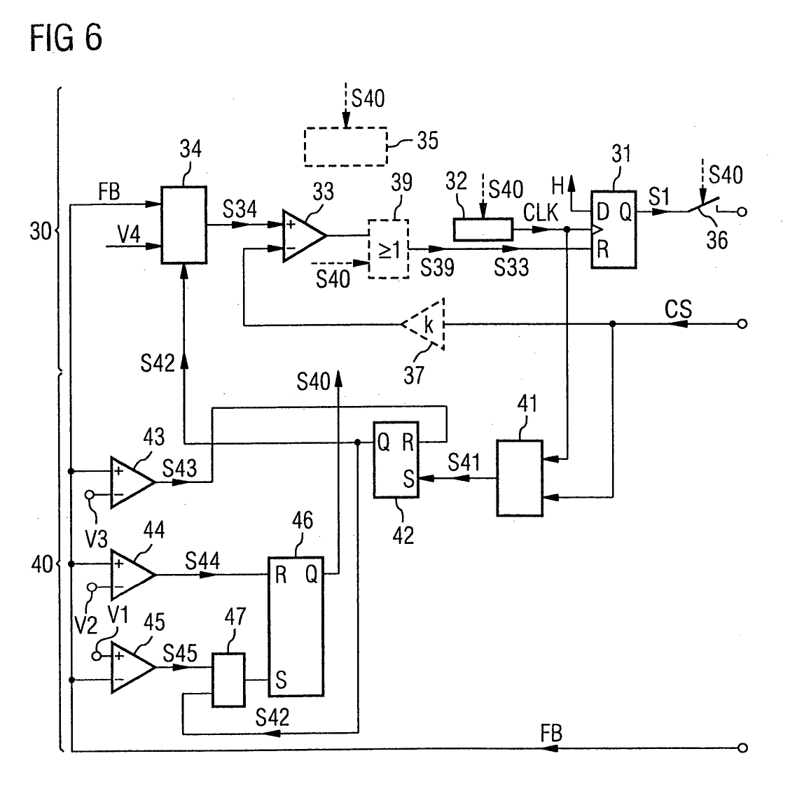

FIG. 6 shows a first exemplary implementation of the drive circuit 20 according to this embodiment of the invention. In this exemplary embodiment, the pulse width modulator 30 has as output stage a flip flop 31, at the output Q of which the drive signal S1 is available. If necessary, this flip flop 31 can be followed by a driver circuit (not shown) which converts the signal level at the output of the flip flop into a level suitable for driving the switch (M in FIG. 1). In the example, the flip flop is constructed as D-type flip flop, the D input of which is permanently at a High level H. The clock input of this flip flop is supplied with a clock signal CLK generated by a clock generator 32, which, in conjunction with the D input, which is permanently at a High level, ensures that the flip flop 31 is set at the clock rate of this clock signal CLK so that the drive signal S1 assumes a High level for conductively driving the switch M at the clock rate of the clock signal CLK. The reset input R of this flip flop 31 is supplied with a reference signal S33 which is generated by a comparator 33 in dependence on the current measurement signal CS and a reference signal S34 supplied to the comparator 33.

The reference signal S34 is available at the output of a multiplexer 34, which is supplied with the feedback signal FB and the current limiting signal V4 for the burst mode. The selection of one of these two signals FB, V4 by the multiplexer 34 is effected as determined by the operating mode signal S42 generated by the enable circuit 40, which determines normal mode or burst mode. In normal mode, the comparator 33 is supplied by the multiplexer 34 with the feedback signal FB as reference signal S34 so that the flip flop 31 is set at the clock rate of the clock signal CLK during the normal mode and is in each case reset via the comparator 33 when the current measurement signal CS reaches the value of the feedback signal FB. During the burst mode, the flip flop 31 is also set at the clock rate of the clock signal CLK and is reset via the reference signal S33 when the current measurement signal CS reaches the value of the current limiting signal V4 for the burst mode.

The comparator 33 is optionally preceded by an amplifier 37 which amplifies the current measurement signal CS and is used for adapting the level of the current measurement signal CS to the level of the feedback signal FB or of the current limiting signal V4 in suitable manner. The current measurement signal CS and its amplified version are both referred to as the current measurement signal for the purposes of the disclosure herein.

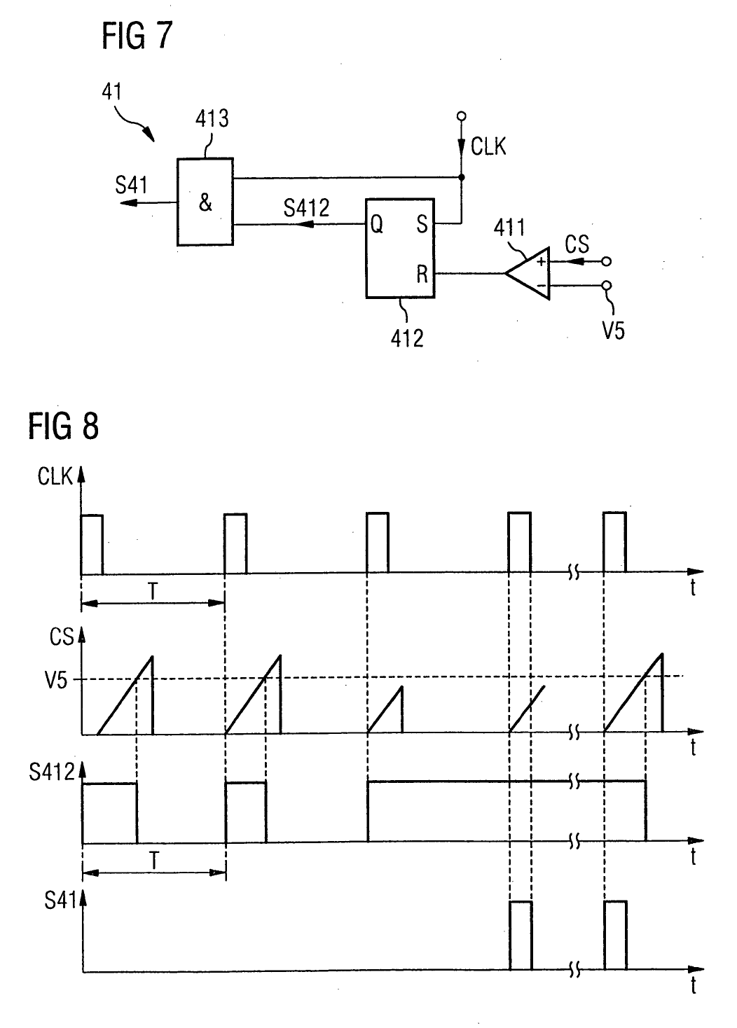

The enable circuit 40 which generates the enable signal S40 for the pulse modulator 30 and the operating mode signal S42 has an evaluating circuit 41 which is supplied with the clock signal CLK and the current measurement signal CS. This evaluating circuit 41 is constructed for evaluating the current measurement signal CS and driving, via an output signal S41, an operating mode flip flop 42, at the output Q of which the operating mode signal S42 is available. (See exemplary embodiment of evaluation circuit 41 FIG. 7, discussed below)

Referring again to FIG. 6, the flip flop 42 is set via the output signal S41 of the evaluating circuit 41 when the current measurement signal CS does not drop below the normal mode limit value (V5 in FIG. 5) at least within one clock period of the clock signal CLK. In this case, the operating mode signal S42 assumes a High level which indicates the burst mode of the drive circuit.

The enable signal S40 is available at the output Q of an enable flip flop 46 which is set in dependence on the operating mode signal S42. In the example, this enable flip flop 46 is set when the pulse width modulator 30 is not to be enabled or blocked, respectively. In the example, the enable signal S40 has a High level for this purpose. It should be pointed out in this context that this enable signal could also be generated, in dependence on the further use of the enable signal S40 in the pulse width modulator 30, in such a manner that it assumes a Low level when the pulse width modulator 30 is not to be enabled.

In the example, the set input S of the enable flip flop 46 is preceded by a logic gate 47, preferably an AND gate, one input of which is supplied with the operating mode signal S42 and the other input of which is supplied with a first reference signal S45. This first reference signal S45 is available at the output of a first comparator 45 which compares the feedback signal FB with the lower threshold value V1. This logical combination of the operating mode signal S42 with the first reference signal S45 is optional and ensures that, after a setting of the operating mode flip flop 42, the pulse width modulator 30 is only blocked when the feedback signal FB drops below the first threshold value V1 which plays a role for the further burst mode (compare FIG. 4).

It will be appreciated that typically the current measurement signal CS, the normal mode limit value V5 and the subthreshold value V1 are preferably matched to one another in such a manner that the control signal FB has already dropped below the first threshold value V1 before the current consumption of the switched-mode converter drops to such an extent that the current measurement signal CS remains below the normal mode limit value V5.

In any event, the enable flip flop 46 is reset by a second reference signal 44 which is available at the output of a second comparator 44. The input of this second comparator 44 is supplied with the feedback signal FB and the first upper threshold value V2. This enable flip flop 46 is reset when the feedback signal FB rises above the first upper threshold value V2 (compare FIG. 4). After the enable flip flop 46 has been reset, the pulse width modulator 30 is enabled again in order to generate a pulse-width-modulated drive signal S1 clocked by the clock signal CLK. The pulse width modulator 30 is operated in burst mode for as long as the operating mode flip flop 42 is set. In this case, the input current is limited during the burst mode by the current limiting signal V4 which is compared with the current measurement signal CS by the comparator 33 of the pulse width modulator 30.

A transition from burst mode into normal mode occurs when the feedback signal FB exceeds the second output threshold value V3. For this purpose, the feedback signal FB is compared with the second upper threshold value V3 by means of a third comparator 43. At the output of this third comparator 43, a third reference signal S43 is available which is supplied to the reset input R of the operating mode flip flop 42 in order to reset this flip flop 42 when the feedback signal FB exceeds the value of the second upper threshold value V3, which indicates that the power consumption of a load (Z in FIG. 1) connected to the switched-mode converter can no longer be covered by the power consumption of the switched-mode converter during the burst mode.

There are various possibilities for enabling or blocking the pulse-width modulator 30 by means of the enable signal S40, which can be applied individually in each case or also combined with one another and which will be explained in the text which follows:

In the case of one possibility, it is provided to permanently reset the output flip flop 31 of the pulse width modulator 30 during the period in which the pulse width modulator 30 is to be blocked. This can be done by connecting an OR gate 39 between the comparator 33 and the reset input R of this flip flop 31 and supplying it with the output signal of the comparator 33 and the enable signal S40 as input signals. The output signal S39 of this OR gate 39 is supplied to the reset input R of the flip flop 31 in order to permanently reset this flip flop as long as the enable signal S40 assumes a High level.

A further possibility for blocking the pulse width modulator 30 consists in switching the clock generator 32 on or off in dependence on the enable signal S40. When the clock generator 32 is switched off, the flip flop 31 will not be set as a result of which a pulse-width-modulated drive signal S1 will not be generated.

A third possibility of blocking the pulse width modulator 30 or preventing the delivery of a pulse-width-modulated drive signal consists in connecting upstream of the output at which the pulse width modulated signal S1 is provided, a switch 36 which is driven by the enable signal S40 and which is constructed in such a manner that it is opened when the enable signal S40 assumes a High level in order to prevent by this means the delivery of a pulse-width-modulated drive signal.

A further possibility of blocking the pulse width modulator 30 consists in interrupting the voltage supply to the individual circuit components of the pulse width modulator 30. FIG. 6 shows diagrammatically an internal voltage supply arrangement 35 which ensures the voltage supply to the individual circuit components of the pulse width modulator 30 in a manner not shown in greater detail. This voltage supply arrangement 35 is constructed for ensuring a voltage supply to the individual circuit components or interrupting this voltage supply, driven by the enable signal S40.

FIG. 7 shows a first exemplary implementation of the evaluating circuit 41, the output signal S41 of which sets the operating mode flip flop 42. This evaluating circuit 41 has a comparator 411 which compares the voltage measurement signal CS with the normal mode limit value V5. An output signal S411 of this comparator 411 is supplied to the reset input R of a flip flop 412, the set input S of which is supplied with the clock signal CLK. An output signal S412 of this flip flop 412 is combined with the clock signal CLK by means of an AND gate 413, the output signal S41 of the evaluating circuit 41 being available at the output of this AND gate 413.

The operation of this evaluating circuit 41 will become clear by referring to the time variation of selected signals occurring in the evaluating circuit 41, shown in FIG. 8. The flip flop 411 is set at the clock rate of the clock signal CLK and is reset whenever the current measurement signal CS exceeds the normal mode limit value V5. If the current measurement signal CS exceeds the normal mode limit value during a clock period of the clock signal CLK, the flip flop 412 will be reset in each case at the beginning of a new clock period so that the output signal of the AND gate 413 permanently assumes a Low level. From time t1 onward, a drive period in which the current measurement signal CS does not exceed the normal mode limit value V5 is shown in FIG. 8. As a result, the flip flop 412 is still set at the beginning of a subsequent clock period CLK so that the output signal of the AND gate assumes a High level during the period of one clock pulse of the clock signal CLK as a result of which the operating mode flip flop (42 in FIG. 6) is set.

The internal flip flop 412 of the evaluating circuit 41 is reset when the current measurement signal CS again exceeds the normal mode limit value during a later clock period.

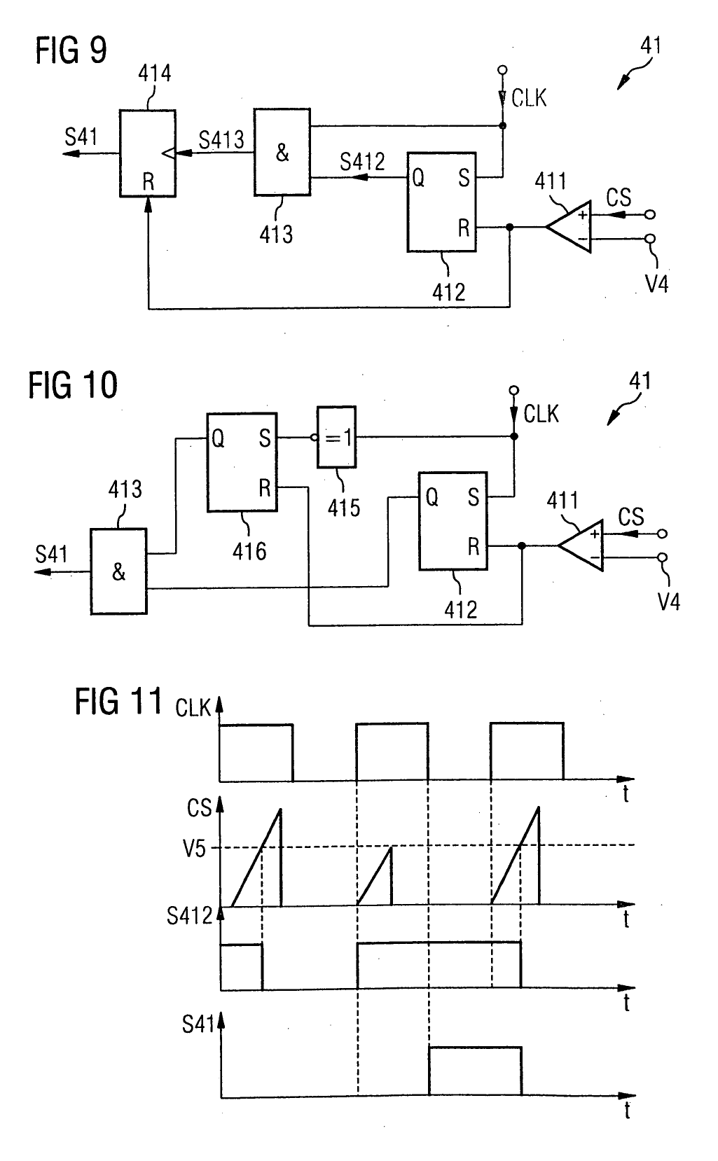

FIG. 9 shows an exemplary embodiment of the evaluating circuit 41 which differs from that shown in FIG. 7 in that the AND gate 413 is followed by a counter 414, at the output of which the output signal S41 of the evaluating circuit is available. This counter 414 is constructed in such a manner that it only generates a High level of the output signal S41 after a predetermined number of clock pulses have occurred at the output of the AND gate 413, that is to say after the current measurement signal CS has not exceeded the normal mode limit value V5 during a predetermined number of successive clock periods. The counter 414 is reset via the output signal of the comparator 411 at the same time as the internal flip flop 412 is reset.

FIG. 10 shows a further exemplary embodiment of the evaluating circuit 41 which is suitable, in particular, when a clock signal CLK is available in which the duration of the individual clock pulse is long in comparison with the time passing from the beginning of a clock pulse until the current measurement signal CS usually exceeds the normal mode limit value V5. In addition to the flip flop 412 which is set via the clock signal CLK, this evaluating circuit 41 has a further flip flop 416 which is in each case set with a falling edge of the clock pulses of the clock signal CLK. For this purpose, the clock signal CLK is supplied to the set input of this flip flop 416 via an inverter 415. This flip flop 416 is reset at the same time as the flip flop 412 is reset via the output signal of the comparator 411.

The two output signals of the flip flops 412, 416 are jointly supplied to the AND gate 413 at the output of the evaluating circuit 41.

Referring to the variations with time, shown in FIG. 11, of the signals occurring in the evaluating circuit 41 according to FIG. 10, a High level of the output signal S41 is already generated in this evaluating circuit according to FIG. 10 with a falling edge of a clock pulse when the current measurement signal CS has not exceeded the normal mode limit value V5 during the period of this clock pulse. The operating mode flip flop (42 in FIG. 6) in this evaluating circuit 41 is already set earlier than in the evaluating circuit according to FIG. 7, in which a High level of the output signal S41 is only generated at the beginning of a following clock period.

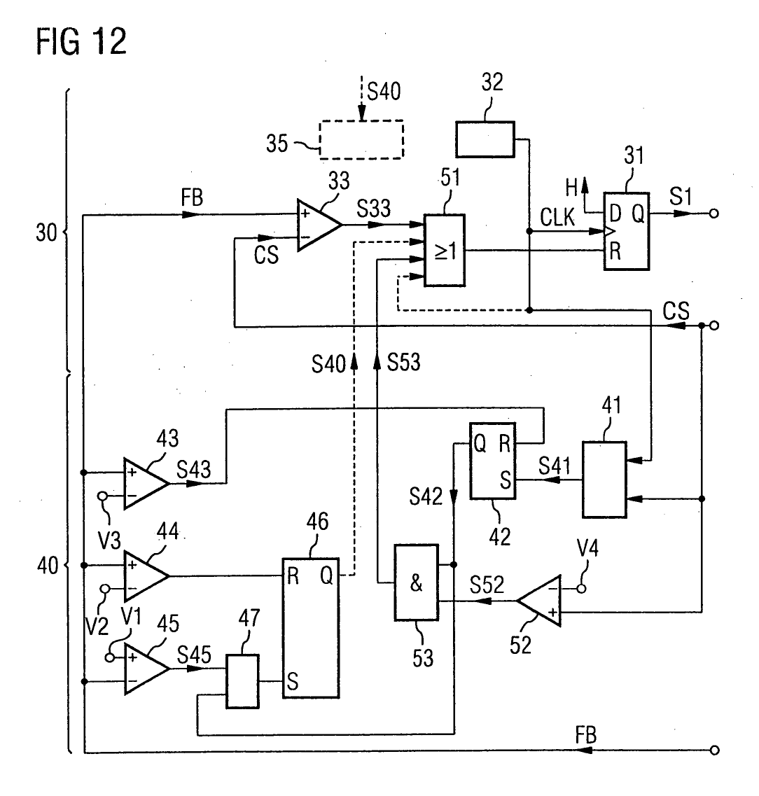

FIG. 12 shows a modification of the drive circuit shown in FIG. 6. This drive circuit differs from that shown in FIG. 6 in that there is a separate comparator 52 for comparing the current measurement signal CS with the current limiting value V4. An output signal S52 of this comparator is supplied to an AND gate 53 together with the operating mode signal S42. The output signal S53 of this AND gate, together with the output signal S33 of the comparator 33, is supplied to an OR gate 51, the output signal of which is supplied to the reset input of flip flop 31. In this drive circuit, the flip flop 31 is reset via the comparator 33 and the OR gate 51 when the current measurement signal CS reaches the value of the feedback signal FB, or via the further comparator 52, the AND gate 53 and the OR gate 51, when the current measurement signal CS reaches the value of the current limiting value V4 during the burst mode. This makes use of the fact that the current limiting value V4 during the burst mode is selected in such a manner that it is lower than the control signal FB so that, during burst mode, the flip flop 31 is exclusively reset in dependence on the output signal S53 of the AND gate 53. During normal mode, when the operating mode signal S42 assumes a Low level, the flip flop 31 is reset exclusively in dependence on the output signal of the comparator 33.

The OR gate 51 is optionally also supplied with the enable signal S40 which ensures that the generation of the drive signal S1 is interrupted immediately with a transition from normal mode into burst mode. In addition, supplying the enable signal S40 to the OR gate 51 during burst mode ensures that no drive signal is generated during such periods during which the pulse width modulator 30 is to be blocked.

There is also optionally the possibility of supplying the clock signal CLK to the OR gate 51. This possibility can be used, in particular, when the clock signal CLK has a duty cycle which is greater than the duty cycle of the pulse width modulated drive signal S1 occurring during interference-free operation. Including the clock signal CLK into the generation of the reset signal for the flip flop 31 has the effect that when a fault occurs, the duty cycle of the drive signal S1 is limited to the value of the duty cycle of the clock signal CLK.

FIG. 13 shows a modification of the drive circuit shown in FIG. 12, which has a current limiting circuit 70 acting during normal operation of the drive circuit. This current limiting circuit compares the current measurement signal CS with a current limiting signal V6. To compare the current measurement signal CS with the current limiting signal V6, there is a comparator 71, one input of which is supplied with the current measurement signal CS and the other input of which is supplied with the current limiting signal V6. An output signal S70 available at the output of the comparator 71 is supplied to the OR gate 51. This current limiting arrangement 70 has the effect that, during normal mode, the output flip flop 31 is reset when the current measurement signal CS has risen up to the value of the limiting signal V6 as a result of which the current through the primary coil (Lp in FIG. 1) is limited to a maximum value dependent on the current limiting value V6.

The current limiting signal V6 is preferably supplied to a compensation arrangement 72 which varies this limiting signal V6 in dependence on the input voltage of the switched-mode converter (Vin in FIG. 1) in order to ensure that the maximum power consumed by the switched-mode converter is always limited to the same value. This is based on the finding that the switch (M in FIG. 1) due to existing signal delays, still remains switched on for the duration of the signal delays after the current measurement signal CS has reached the value of the limiting signal V6. The value by which the input current (I in FIG. 1) rises during this signal delay is dependent on the input voltage Vin and the greater the input voltage Vin, the greater this value. The compensation circuit 72 is constructed for reducing the limit value V6 with increasing input voltage Vin in order to always achieve an identical maximum power consumption, taking into consideration the signal delay. Such a compensation circuit 72 is known in principle and described, for example, in DE 100 40 413 A1 so that further statements in respect of this circuit can be omitted.

The further comparator 52 is preferably also preceded by a corresponding compensation circuit 54 which varies the current limiting value, which is effective during the burst mode, in dependence on the input voltage Vin so that the power consumption of the switched-mode converter is in each case identical independently of on the input voltage Vin during the switching-on phases in burst mode.

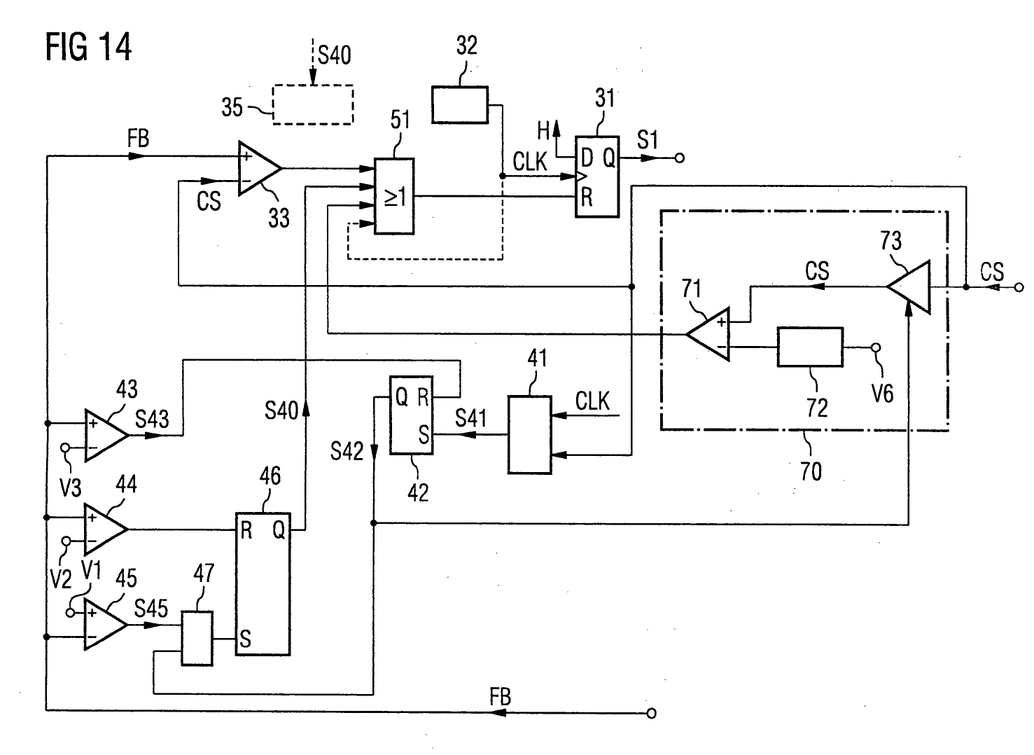

FIG. 14 shows a modification of the drive circuit shown in FIG. 13. The drive circuit shown in FIG. 14 differs from that shown in FIG. 13 in that the current limiting circuit 70 is used both for limiting the maximum power consumption during normal mode and for limiting the current or power consumption during the burst mode. For this purpose, the current limiting circuit 70 has a controllable amplifier 73 which is driven by the operating mode signal S42. During normal mode, the gain of this amplifier 73 is, for example, one so that the limiting circuit 70, during normal mode, operates in accordance with the limiting circuit explained with reference to FIG. 13, which only becomes active when the current measurement signal CS rises above the limit value V6 which may be modified by the compensation circuit 72.

The amplifier 73 is constructed in such a manner that it has a gain of greater than one during the burst mode, that is to say when the operating mode signal S42 assumes a High level.

The amplified current measurement signal present at the output of this amplifier 73 is adapted to the value of the current limiting signal V6 in such a manner that the amplified current measurement signal reaches the current limit value V6 during burst mode before the unamplified current measurement signal CS reaches the value of the control signal FB. During the burst mode, the current limiting arrangement 70 is used for limiting the input current to a value dependent on the limiting signal V6.

1. A method for driving a semiconductor switch, connected in series with a first coil of a transformer in a switched-mode converter, the method comprising:
a) driving the switch in a first drive mode, wherein the switch is continuously driven by a first pulse-width-modulated drive signal having a number of drive periods, each drive period having an on-time and an off-time,
b) driving the switch in a second drive mode, wherein the switch is driven intermittently by a second pulse-width-modulated drive signal, and
c) changing from the first drive mode to the second drive mode in dependence on whether a maximum value of a current through the first coil exceeds a predetermined current threshold value during at least one drive period.

2. The method as claimed in claim 1, wherein step a) further comprises effecting control of the first pulse-width modulated signal based at least in part on a control signal, the control being dependent on the output voltage of the switched-mode converter.

3. The method as claimed in claim 1, wherein step c) further comprises changing from the first drive mode to the second drive mode also in dependence on whether of a control signal either exceeds or is less than a predetermined first threshold value, the control signal being dependent on an output voltage of the switched-mode converter.

4. The method as claimed in claim 1, wherein step c) further comprises changing from the first drive mode to the second drive mode in dependence on whether the maximum value of the current through the first coil exceeds the predetermined current threshold value during a predetermined number of successive drive periods of the drive signal.

5. The method as claimed in claim 2, wherein step b) further comprises changing between providing the second pulse-width-modulated drive and interrupting the second pulse-width-modulated drive in dependence on a comparison of the control signal with a first threshold value and a second threshold value, the second threshold value different than the first threshold value.

6. The method as claimed in claim 5, in which the second threshold value is selected such that the control signal, starting from a value between the first threshold value and the second threshold value, approaches the second threshold value when the output voltage drops, and wherein step b) further comprises:
providing the second pulse-width-modulated drive responsive to the control signal reaching the second threshold value; and
interrupting the second pulse-width-modulated drive responsive to the control signal reaching the first threshold value.

7. The method as claimed in claim 2, further comprising:
d) changing from the second drive mode to the first drive responsive to a comparison of the control signal with a threshold value.

8. The method as claimed in claim 5, further comprising:
d) changing from the second drive mode to the first drive responsive to a comparison of the control signal with a third threshold value which is selected such that the control signal approaches the third threshold value starting from the second threshold value as the output voltage drops.

9. The method as claimed in claim 2, wherein the drive periods of the first pulse-width-modulated drive signal in the first drive mode are dependent on the variation of the current through the first coil and the control signal.

10. The method as claimed in claim 1, wherein drive periods of the second pulse-width-modulated drive signal in the second drive mode are dependent on the variation of the current through the first coil and on a current limiting signal.

11. The method as claimed in claim 1, wherein step a) further comprises using the switch to limit the current through the first coil to a predetermined maximum value.

12. A drive circuit for a semiconductor switch, which is connected in series with a first coil of a transformer in a switched-mode converter, the switched mode converter having input terminals configured to receive an input voltage and an output terminals configured to provide an output voltage, the drive circuit comprising:
an output connection operably connected to provide a drive signal for the semiconductor switch,
a current measurement configured to receive a measurement signal depending on a current through the first coil,
a feedback input configured to receive a control signal depending on the output voltage,
a signal generating circuit constructed to generate, in a first drive mode, a first pulse-width-modulated signal continuously as the drive signal, and constructed to generate, in a second drive mode, a second pulse-width-modulated signal intermittently as the drive signal, wherein a transition from the first drive mode to the second drive mode occurs in dependence on the current measurement signal.

13. The drive circuit as claimed in claim 12, wherein the signal generating circuit comprises a pulse width modulator operably connected to receive the control signal and an enable signal.

14. A method for driving a semiconductor switch, connected in series with a first coil of a transformer in a switched-mode converter, the method comprising
a) driving the switch continuously using a first pulse-width-modulated drive signal; and
b) driving the switch intermittently using a second pulse-width-modulated signal, responsive to whether a maximum value of a current through the first coil exceeds a predetermined current threshold value during at least one drive period of the first pulse-width-modulated drive signal.

15. The method as claimed in claim 14, wherein step a) further comprises effecting control of the first pulse-width modulated signal based at least in part on a control signal, the control being dependent on the output voltage of the switched-mode converter.

16. The method as claimed in claim 14, wherein step b) further comprises driving the switch intermittently using the second pulse-width-modulated signal, also in dependence on whether of a control signal either exceeds or is less than a predetermined first threshold value, the control signal being dependent on an output voltage of the switched-mode converter.

17. The method as claimed in claim 15, wherein step b) further comprises
changing between providing the second pulse-width-modulated drive and interrupting the second pulse-width-modulated drive in dependence on a comparison of the control signal with a first threshold value and a second threshold value, the second threshold value different than the first threshold value.

18. The method as claimed in claim 17, in which the second threshold value is selected such that the control signal, starting from a value between the first threshold value and the second threshold value, approaches the second threshold value when the output voltage drops, and wherein step b) further comprises:
providing the second pulse-width-modulated drive responsive to the control signal reaching the second threshold value; and
interrupting the second pulse-width-modulated drive responsive to the control signal reaching the first threshold value.

19. The method as claimed in claim 18, wherein step b) further comprises returning to step a) responsive to a comparison of the control signal with a threshold value.

20. The method as claimed in claim 15, wherein drive periods of the pulse-width-modulated drive signal in the first drive mode are dependent on the variation of the current through the first coil and the control signal.
